(19) United States
(12) Patent Application Publication
(10) Pub. No.: US 2012/0000899 A1
(43) Pub. Date: Jan. 5, 2012

(54) HEATER FOR REFRIGERATOR AND REFRIGERATOR INCLUDING THE SAME

(76) Inventors: Chang-Won Eom, Changwon City (KR); Hong-Seok Park, Changwon City (KR); Jin-Soo Park, Changwon-City (KR)

(21) Appl. No.: 13/256,691

(22) PCT Filed: Jan. 28, 2010
(86) PCT No.: PCT/KR2010/000514

§ 371 Date: Sep. 15, 2011

(30) Foreign Application Priority Data
May 5, 2009 (KR) 10-2009-0039067

(51) Int. Cl. H05B 1/00; H05B 3/02

(52) U.S. Cl. 219/385

(57) ABSTRACT

Provided is a refrigerator in which a heating member is used to reduce power consumption of the refrigerator. According to the refrigerator, a carbon nanotube (CNT) heater is used as the heating member of the refrigerator. Since it can be possible to quickly heat a heating object due to sheet resistance properties of the CNT material, necessary power consumption can be prevented to improve the power consumption.

### TECHNICAL FIELD

The present disclosure relates to a refrigerator.

### BACKGROUND ART

Generally, a refrigerator is a home appliance, which stores foods in a storage space that is covered by a refrigerator door to keep foods at low temperatures, and enables foods to be stored in a fresh state by cooling the inside of the storage space using cold air generated through heat exchange with refrigerant that circulates through a cooling cycle.

The storage space within the refrigerator is divided into a refrigerator compartment that is maintained at a temperature of about 1° C. to about 4° C. to store foods such as vegetables in a fresh state and a freezer compartment that is maintained at about 18° C. below zero to store foods such as meats and fishes in a frozen state.

Various types of refrigerators may be provided according to an arrangement of the refrigerator compartment and the freezer compartment and configurations of refrigerator doors that cover the refrigerator compartment and the freezer compartment, respectively.

In the refrigerator, a temperature difference between spaces within the refrigerator or between the inside of the refrigerator and the outside may occur. Thus, due to this temperature difference, dew condensation may occur on a portion at which the temperature difference occurs.

Reliability of a product is reduced due to the dew condensation, and also, there is a limitation to use the refrigerator when the dew is frozen.

In a related art, to overcome such the limitation, a heating member is installed at a portion at which a temperature difference occurs to locally heat a position that contacts a high temperature position. The heating member may include a sheath heater or a positive temperature coefficient (PTC) heater.

As necessary, a heater is used as the heating member to use a hot gas pipe that is disposed around by a hot gas to prevent the dew from being frozen.

However, according to a related art refrigerator, as the heating member or the hot gas pipe is utilized, a temperature within the refrigerator increases, and cooling efficiency or power consumption of the refrigerator is deteriorated.

### DISCLOSURE OF INVENTION

### Technical Problem

Embodiments provide a refrigerator in which a heating member for reducing a power consumption thereof is utilized.

### Solution to Problem

In one embodiment, a heater for a refrigerator includes: an insulation sheet constituting the refrigerator and disposed on a heating object at which heat is required, the insulation sheet being disposed at a side of a heating part; a plurality of electrodes coupled to the insulation sheet, the electrodes supplying a power; and a heating element disposed between the plurality of electrodes, the heating element being formed of carbon nanotube (CNT) to generate the heat.

In another embodiment, a refrigerator includes: a cabinet defining a storage space; a refrigerator compartment defined at an upper portion of the storage space, the refrigerator compartment storing foods in a refrigeration state; a freezer compartment defined at a lower portion of the storage space, the freezer compartment storing the foods in a frozen state; a barrier partitioning the refrigerator compartment and the freezer compartment; a plurality of doors selectively covering the refrigerator compartment and the freezer compartment; and a carbon nanotube (CNT) heater disposed on the cabinet or doors, the CNT heater being formed of carbon nanotube to provide a heat source.

In further another embodiment, a refrigerator includes: a cabinet defining a storage chamber partitioned into left and right sides by a partition; a door selectively covering the storage chamber; and a carbon nanotube (CNT) heater disposed on the cabinet or doors, the CNT heater being formed of carbon nanotube to provide a heat source.

The details of one or more embodiments are set forth in the accompanying drawings and the description below. Other features will be apparent from the description and drawings, and from the claims.

### Advantageous Effects of Invention

In the refrigerator according to the embodiments, the CNT heater is used as the heating member of the refrigerator. Since it can be possible to quickly heat the heating object due to sheet resistance properties of the CNT material, necessary power consumption can be prevented to improve the power consumption.

According to the properties of the CNT material, a resistance can be easily regulated to satisfy various temperature conditions.

Since the CNT heater can be modified into linear, surface, and three-dimensional shapes, the CNT heater can be easily applied to the heating object even through the heating object has a complicated structure.

Also, since the CNT heater can be modified to uniformly transfer heat on the wide area of the heating object, it can prevent the CNT heater from interfering with other components due to the installation of the heating element. Also, it can prevent the heating object from being damaged due to local heating.

In the CNT heater, when the plurality of heating elements is spaced from each other, the heating function can be continuously performed even through one of the heating elements is shorted.

When compared to a related art heating member, the CNT heater has a superior physical properties. Thus, the CNT heater can be permanently used. In addition, since the CNT heater is not easily damaged by a physical impact or resistance, durability can be improved.

### BRIEF DESCRIPTION OF DRAWINGS

FIG. 1 is a perspective view of a bottom freezer type refrigerator according to a first embodiment.

FIGS. 2 and 3 are schematic views illustrating a structure of a CNT heater according to the first embodiment.

FIG. 4 is a sectional view of the CNT heater according to the first embodiment.

FIG. 5 is a perspective view illustrating an installation example of the CNT heater according to the first embodiment.

FIG. 6 is a partially perspective view of a refrigerator compartment door according to the first embodiment.

FIG. 7 is a partially perspective view of a barrier and a cool air duct according to the first embodiment.

FIG. 8 is an enlarged view illustrating a portion A of FIG. 1.

FIG. 9 is a plan view illustrating a top surface of an inner case according to the first embodiment.

FIG. 10 is a perspective view of a side-by-side type refrigerator according to a second embodiment.

FIG. 11 is a perspective view of a refrigerator with a door opened according to the second embodiment.

FIG. 12 is an exploded perspective of the door according to the second embodiment.

FIG. 13 is a sectional view of an ice making apparatus according to the second embodiment.

FIG. 14 is a sectional view taken along line B-B′ of FIG. 10.

FIG. 15 is a perspective view illustrating a back surface of a dispenser housing according to the second embodiment.

FIGS. 16 and 17 are partially perspective views of a state in which a home bar door is opened according to the second embodiment.

FIG. 18 is a perspective view of a heat-exchanger in which a CNT heater is installed according to the second embodiment.

FIG. 19 is a perspective view of a heat-exchanger in which a CNT heater is installed according to a third embodiment.

FIG. 20 is a perspective view of a drain part in which a CNT heater is installed according to a fourth embodiment.

FIG. 21 is a perspective view of a chest type refrigerator with a door opened according to a fifth embodiment.

FIG. 22 is a perspective view of an inner case according to the fifth embodiment.

### MODE FOR THE INVENTION

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

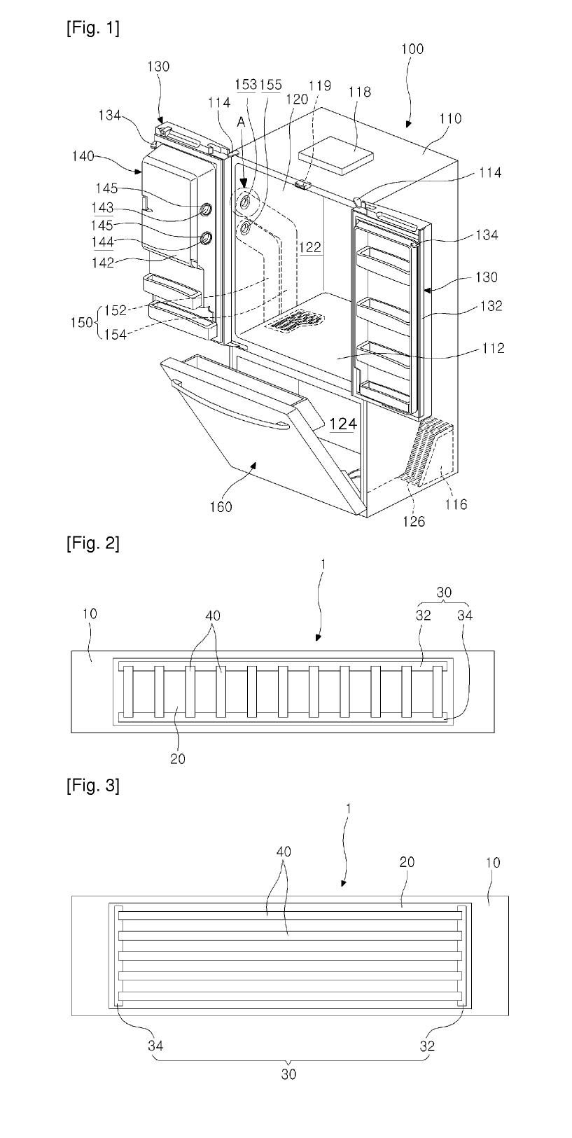

FIG. 1 is a perspective view of a bottom freezer type refrigerator according to a first embodiment.

Referring to FIG. 1, a refrigerator 100 according to this embodiment includes a cabinet 110 having a an approximately rectangular parallelepiped shape and doors 130 and 160 installed on an opened front surface of the cabinet 110.

An inner case 120 defining storage spaces such as a refrigerator compartment 122 and a freezer compartment 124 is disposed inside the cabinet 110. An insulation material is disposed in a space between the inner case 120 and the cabinet 110. The storage spaces are thermally insulated from the outside.

The inner case 120 is vertically partitioned by a barrier 112. The refrigerator compartment is defined at an upper side of the barrier 112, and the freezer compartment is defined at a lower side of the barrier 112.

The refrigerator compartment is opened and closed by a refrigerator compartment door 130. The refrigerator door 130 is provided in a pair at left and right sides. The refrigerator door 130 is rotatably coupled to the cabinet 110 using a hinge 114.

An ice compartment 140 opened and closed by an ice compartment door 142 is defined in an inner sidewall of the refrigerator compartment door 130.

The ice compartment 140 provides an independent space insulated from the refrigerator compartment 122. Cool air generated in a heat-exchanger 126 may be supplied to the ice compartment 140 by a cool air duct 150. Here, the cool air duct 150 may be disposed between the cabinet 110 and the inner case 120.

An ice making apparatus (not shown) for making and storing an ice is disposed within the ice compartment 140. The ice made by the ice making apparatus is dispensed to the outside through a dispenser (not shown) disposed in a front surface of the refrigerator compartment door 130.

The freezer compartment 124 is opened and closed by a freezer compartment door 160. The freezer compartment door 160 is withdrawably provided in a drawer type.

A receiving basket withdrawable together with the freezer compartment door 160 may be provided on a back surface of the freezer compartment door 160. As necessary, a separate component for receiving may be provided within the freezer compartment door 160.

A machine room including a plurality of components such as a compressor, condenser, and expansion unit, which constitute a refrigeration cycle may be disposed at a rear side of the freezer compartment 124. The machine room is separately partitioned from the freezer compartment 124. The heat-exchanger 126 generating the cool air for cooling the inside of the refrigerator may be disposed at a rear side of the freezer compartment 124.

A portion of the cool air generated in the heat-exchanger 126 is discharged into the freezer compartment 124 to cool the freezer compartment 124, and another portion of the cool air is supplied to the refrigerator compartment 122 to cool the refrigerator compartment 122.

Also, further another portion of the cool air generated in the heat-exchanger is supplied to the ice compartment 140 through the cool air duct 150 to make the ice.

A control box 118 for controlling an operation of the refrigerator 100 is disposed on a top surface of the cabinet 110.

A heater (hereinafter, referred to as a “carbon nanotube (CNT) heater”) formed of carbon nanotube material is disposed in the refrigerator 100. The CNT heater 1 is disposed at a portion of the refrigerator at which heat is required. The CNT heater 1 generates heat when a power is applied.

The CNT heater 1 may be disposed at portions such as an inner end adjacent to the refrigerator compartment door 130, the cool air duct 150, the barrier 112 adjacent to the cool air duct 150, a cool air outlet 153 and cool air inlet 155 of the cool air duct 150, a portion of the inner case 120 at which the control box 118 is disposed, and a portion of the inner case 120 at which a cam holder 119 is disposed.

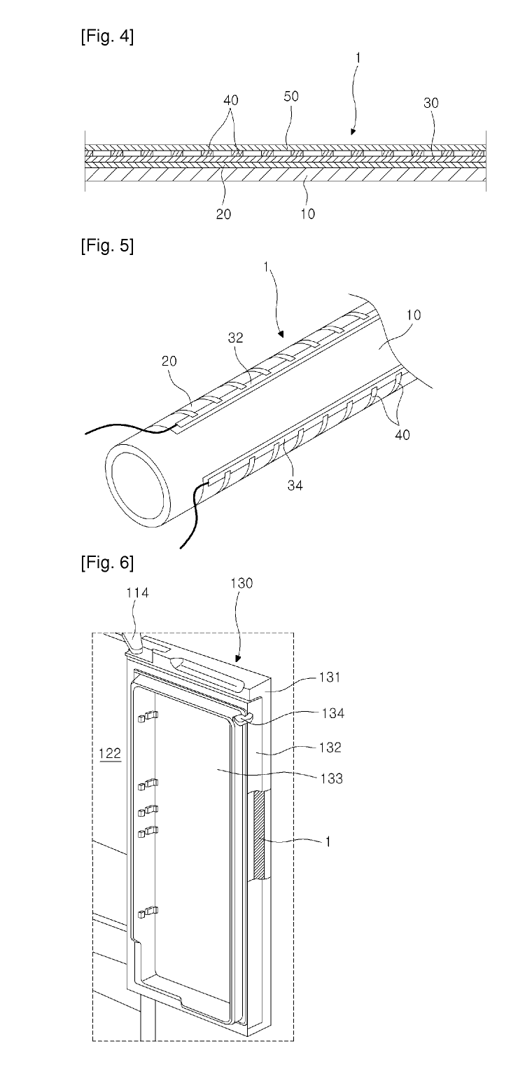

FIGS. 2 and 3 are schematic views illustrating a structure of a CNT heater according to the first embodiment. FIG. 4 is a sectional view of the CNT heater according to the first embodiment. FIG. 5 is a perspective view illustrating an installation example of the CNT heater according to the first embodiment.

Referring to FIGS. 2 to 5, the CNT heater 1 is disposed on a surface of a part 10 that will be heated (hereinafter, referred to as a “heating object”). At this time, the heating object 10 is a part of the refrigerator. Also, the heating object 10 may represent any one portion (constitution) of a plurality of heating parts at which heating (heat generation) is required.

The CNT heater 1 includes an insulation sheet 20 attached to an outer surface of the heating object 10, a plurality of electrodes 30 fixed to a top surface of the insulation sheet 20, a plurality of heating elements 40 respectively fixed to top surfaces of the plurality of electrodes 30, and an anti-oxidation layer 50 fixed to top surfaces of the plurality of heating elements 40 to prevent the heating elements from being oxidated by external air or cool air. Here, the anti-oxidation layer 50 may be coated on the heating elements 40.

In detail, the insulation sheet 20 easily fixes the heating elements 40 to the heating object 10 and protects the heating elements 40 and the heating object 10.

The electrode 30 is provided in a pair, and the pair of electrodes 30 is disposed parallel to each other. The pair of electrodes 30 is a part for supplying a power to the plurality of heating elements 40. One electrode 30 corresponds to a positive electrode, and the other electrode 30 corresponds to a negative electrode. The respective electrodes 30 are connected to an electric wire.

As illustrated in FIGS. 2 and 3, the electrodes 30 may extend in a longitudinal direction of the heating object 10 or in a direction perpendicular to the longitudinal direction of the heating object 10.

The plurality of heating elements 40 are sequentially disposed spaced a preset distance from each other in the longitudinal direction of the heating object 10 or in the direction perpendicular to the longitudinal direction of the heating object 10. Each of the heating elements 40 has one end contacting a top surface of one electrode 32 and the other end contacting a top surface of the other electrode 32.

The heating element 40 is formed using a carbon nanotube as a material. The carbon nanotube represents a material in which six hexagonal configurations are connected to each other to form a tube shape.

In detail, the carbon nanotube has a lightweight and a superior electrical resistance. Also, the carbon nanotube has superior heat conductivity of about 1,600 W/mK to about 6,000 W/mK when compared to that of copper (about 400 W/mK). The carbon nanotube has the electrical resistance of about 10⁻⁴ ohm/cm about 10⁻⁵ ohm/cm, similar to that of copper.

In this embodiment, by using such properties of the carbon nanotube, the carbon nanotube is used as a heating source for heating the heating object 10.

When current is applied to the pair of electrodes 30 in a state where the carbon nanotube is fixed to the insulation sheet 20, the carbon nanotube generates heat.

Here, the carbon nanotube may be fixed to the insulation sheet 20 by coating the carbon nanotube on the insulation sheet 20. A state in which the carbon nanotube is coated on the insulation sheet 20 may be referred to as the heating element 40.

The heating element 40 may be coated and coupled on/to a side of the heating object 10.

When the CNT heater 1 is used as a heating source of the heating object 10, the heating element may be permanently utilized. Also, since the heating element may be easily processed in shape, the heating object having various shapes may be applicable.

When the heating element 40 formed of the carbon nanotube material is applied to the heating object 10, the CNT heater 1 itself may be reduced in volume, and a refrigerant may be quickly heated.

For example, when the heating element 40 formed of the carbon nanotube material uses a positive temperature coefficient (PTC) device or a sheath heater as a heating source, its volume may be significantly reduced, and also, power consumption may be reduced.

The heating element 40 may have a surface having a configuration corresponding to that of the heating object 10. As necessary, the surface may correspond to a portion of the heating object 10 or an entire surface of the heating object 10.

The heating element 40 may be formed in a separate block or three-dimensional shape and coupled to the heating object 10. The heating element 40 may adhere to the heating object 10 or the insulation sheet 20 using an adhesive. Alternatively, the heating element 40 may be coupled to the heating object 10 or the insulation sheet 20 using a separate coupling member.

The heating element 40 itself may constitute at least portion of the heating object 10. That is, the heating element 40 may be integrated with the heating object 10.

Referring to FIG. 5, when the heating object 10 has a pipe or wire shape, the electrodes 30 of the CNT heater 1 may be disposed on both sides of the heating object 10, and the heating element 40 may contact the electrodes 30 while it surrounds the heating object 10.

Hereinafter, a case in which the above-described CNT heater 1 is installed at each portion of the refrigerator will be described. Also, a structure of the CNT heater 1 will not be described below in detail. That is, the CNT heater 1 has any one structure of the above-described structures.

FIG. 6 is a partially perspective view of a refrigerator compartment door according to the first embodiment.

Referring to FIG. 6, the refrigerator compartment door 130 includes an outer case 131 in which a steel sheet is bent to define a front surface and lateral surfaces of the refrigerator compartment door 130 and a door liner 133 coupled to the outer case 131 to define a back surface of the refrigerator compartment door 130. The insulation material is disposed between the outer case 131 and the door liner 133.

The refrigerator compartment door 130 is rotatably disposed on each of both left and right sides of a front surface of the refrigerator.

A lateral gasket 132 allowing front ends of the inner sidewalls of the refrigerator compartment doors 130 to be closely attached to each other in a state where the refrigerator compartment doors 130 are closed is disposed on each of both refrigerator compartment doors 130. A cam member 134 is disposed on an upper portion of the lateral gasket 132.

The cam holder 119 selectively coupled to the cam member 134 is disposed on an upper portion of the inner case 120. The cam member 134 may be coupled to the cam holder 119 in the state where the refrigerator compartment door 130 is closed.

When the refrigerator compartment door 130 is opened, the cam member 134 is separated from the cam holder 119 to rotate the lateral gasket 132. In this process, the lateral gaskets 132 closely attached to each other may be easily separated from each other.

According to properties of the refrigerator compartment door 130, dew condensation may occur on a lateral surface of each of the refrigerator compartment doors 130 contacting each other because air within the refrigerator contacts air outside the refrigerator. To prevent the dew condensation from occurring, the CNT heater 1 is installed on the lateral surface of the respective refrigerator compartment doors 130.

In detail, the CNT heater 1 is installed on a lateral surface of the outer case 131, i.e., an inner sidewall of the outer case 131 corresponding to a surface on which the lateral gasket 132 is disposed.

The CNT heater 1 has a length corresponding to that of the refrigerator compartment door 130 and a width corresponding to that of the lateral gasket 132.

Since the CNT heater 1 is closely attached to the inner sidewall of the outer case 131, the CNT heater 1 may be damaged or its position may be changed when the insulation material within the refrigerator compartment door 130 is foamed.

When the frequency of opening and closing of the refrigerator compartment door 130 exceeds a preset number or a preset time is elapsed, a power is applied to the CNT heater 1 to generate heat. As the CNT heater 1 generates the heat, it may prevent the dew condensation from occurring on the lateral surface of the lateral gasket 132 or the refrigerator compartment door 130.

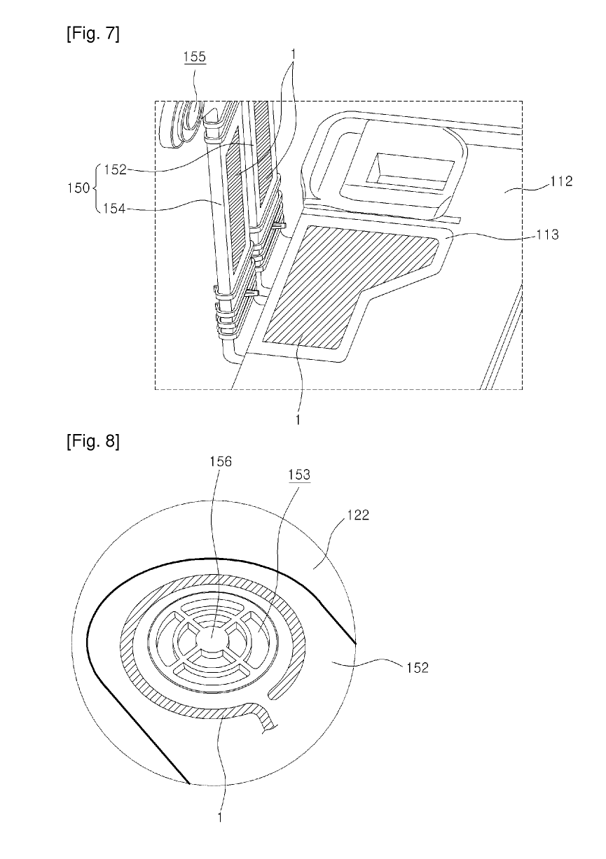

FIG. 7 is a partially perspective view of a barrier and a cool air duct according to the first embodiment, and FIG. 8 is an enlarged view illustrating a portion A of FIG. 1.

Referring to FIGS. 7 and 8, the heat-exchanger 126 according to the first embodiment is disposed in the freezer compartment 124. The cool air generated in the freezer compartment 124 may be guided to the ice compartment 140 through the cool air duct 150.

The cool air duct 150 includes a supply duct 152 for guiding the cool air from the heat-exchanger 126 toward the ice compartment 140 and a return duct 154 for guiding again air heat-exchanged in the ice compartment 140 toward the heat-exchanger 126.

The cool air duct 150 may be buried in the sidewall of the refrigerator compartment 122. The cool air flowing through the cool air duct 150 may have a temperature less than that within the refrigerator compartment 122. Thus, due to a temperature difference between the inside of the cool air duct 150 and the inside of the refrigerator compartment 122, the dew condensation may occur on the inner sidewall of the refrigerator compartment 122.

The CNT heater 1 may be disposed on a lateral surface of the cool air duct 150 contacting the inner case 120.

The CNT heater 1 may be disposed on a surface of the cool air duct 150 contacting the inner case 120 and extend in a longitudinal of the CNT heater 1. As the CNT heater 1 generates heat, it may prevent the dew condensation from occurring on the inner sidewall of the refrigerator compartment 122.

The cool air duct 150 communicates with a connection member 113 disposed at a side of the barrier 112. The connection member 113 is connected to an inlet of the supply duct 152 and an outlet of the return duct 154. The connection member 113 is opened toward the heat-exchanger 126 of the freezer compartment 124.

The cool air flowing from the heat-exchanger 126 toward the ice compartment 140 and the cool air flowing from the ice compartment 140 toward the heat-exchanger 126 may pass through the cool air duct 150 and the connection member 113.

The connection member 113 is exposed to a top surface of the barrier 112. When the barrier is installed, a top surface of the connection member 113 is adjacent to a bottom surface of the refrigerator compartment 122.

When cool air flows into the connection member 113 at a temperature less than that within the refrigerator compartment 122, the dew condensation may occur on the bottom surface of the refrigerator compartment 122 corresponding to the connection member 113.

To prevent the dew condensation from occurring, the CNT heater 1 may be disposed on a portion of the top surface of the barrier 112, i.e., the top surface of the connection member 113.

The CNT heater 1 may have a configuration corresponding to that of the top surface of the connection member 113 contacting the bottom surface of the refrigerator compartment 122.

Unlike this embodiment, if the connection member is omitted, the CNT heater 1 may be disposed at a portion of the top surface of the barrier 112.

The cool air outlet 153 and the cool air inlet 155, which serve as cool air holes through which the cool air comes in and out are disposed at an end of the cool air duct 150 of the refrigerator compartment 122. The cool air outlet 153 is disposed at an end of the supply duct 152, and the cool air inlet 155 is disposed at an end of the return duct 154.

An ice compartment cool air inlet 143 and an ice compartment cool air outlet 144, which respectively correspond to the cool air outlet 153 and the cool air inlet 155, are disposed in a sidewall of the ice compartment 140.

When the refrigerator compartment door 130 is closed, the cool air outlet 153 communicates with the ice compartment cool air inlet 143, and the cool air inlet 155 communicates with the ice compartment cool air outlet 144.

An ice compartment gasket 145 for preventing the cool air from leaking is disposed on each of the ice compartment cool air inlet 143 and the ice compartment cool air outlet 144. A duct grill 156 for preventing foreign substances from being introduced is disposed on each of the cool air outlet 153 and the cool air inlet 155 of the cool air duct 150.

The CNT heater 1 is disposed on a back surface of the inner case 120 adjacent to the cool air outlet 153 and the cool air inlet 155. The CNT heater 1 is disposed along each of circumferences of the cool air outlet 153 and the cool air inlet 155. Also, the CNT heater 1 has a predetermined width.

Of cause, as necessary, the CNT heater 1 may have a circular shape or a rectangular shape.

According to the above-described components, it may prevent the dew condensation from occurring at positions adjacent to the cool air outlet 153 and the cool air inlet 155 through which the cool air flows.

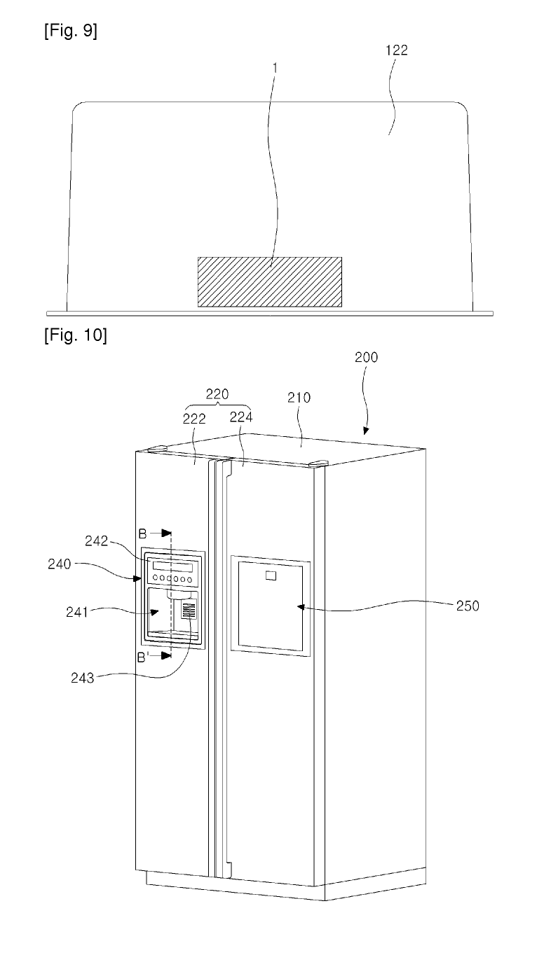

FIG. 9 is a plan view illustrating a top surface of an inner case according to the first embodiment.

Referring to FIG. 9, the CNT heater 1 is disposed at an approximately central portion of the top surface of the inner case 120.

The CNT heater 1 is disposed at a position corresponding to that of the control box 118 to prevent the dew condensation from occurring on the top surface of the cabinet 110 corresponding to the control box 118.

The CNT heater 1 may be disposed on an entire top surface of the cabinet 110. Here, the CNT heater 1 is disposed at a position corresponding to the cam holder 119 to generate the heat, thereby preventing the dew condensation from occurring on the inside of the cam holder 119.

Of course, the CNT heater 1 may have a sufficient size to cover all of the control box 118 and the cam holder 119.

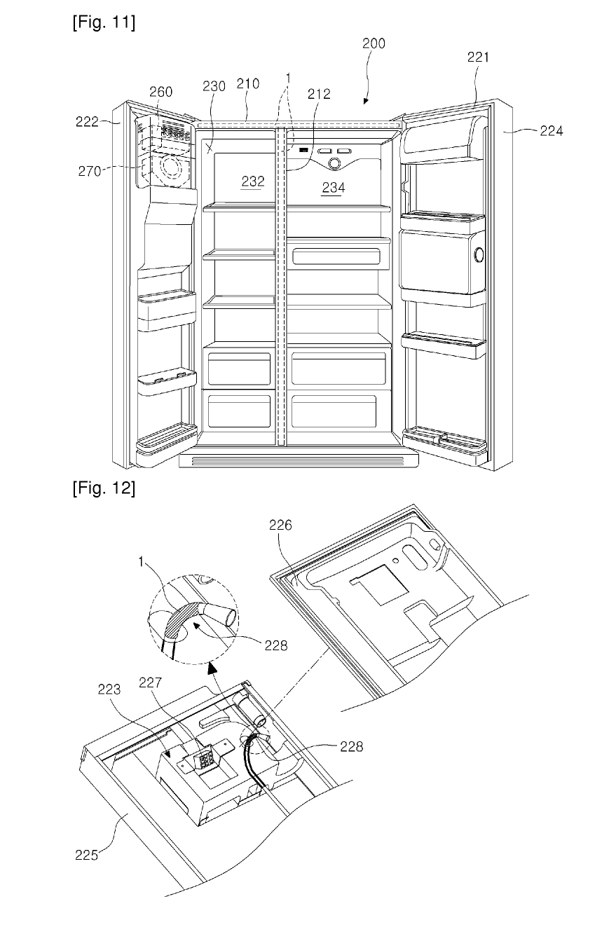

FIG. 10 is a perspective view of a side-by-side type refrigerator according to a second embodiment, and FIG. 11 is a perspective view of a refrigerator with a door opened according to the second embodiment.

Referring to FIGS. 10 and 11, a refrigerator 200 according to this embodiment includes a cabinet 210 defining an outer appearance of the refrigerator 200 and a door 220 opening and closing an opened front surface of the cabinet 210.

An inner case 230 defining a storage space is disposed within the cabinet 210. The storage space is partitioned into left and right spaces by a partition 212 to define a refrigerator compartment 232 and a freezer compartment 234.

The door 220 includes a refrigerator compartment door 224 and a freezer compartment door 222, which selectively open and close the refrigerator compartment 234 and the freezer compartment 232, respectively.

A dispenser 240 for dispensing water or ices to the outside is disposed in the freezer compartment door 222. A home bar 250 for conveniently dispensing frequently used foods may be disposed in the refrigerator compartment door 224.

An ice making apparatus 260 for making the ices is disposed in the freezer compartment door 222. An ice bank 270 is disposed below the ice making apparatus 260. The ices stored in the ice bank 270 may be dispensed through the dispenser 240.

A plurality of shelves, drawers, and baskets for receiving the foods is disposed on the insides and back surfaces of the refrigerator compartment 234 and the freezer compartment 232.

When the door 220 is closed, a gasket 221 of the door 220 may contact a front end of the cabinet 210 or the inner case 230 and a front end of the partition 212. Due to the gasket 221, it may prevent cool air within the refrigerator compartment 232 and the freezer compartment 234 from leaking.

The front end of the cabinet 210 or the inner case 230 and the front end of the partition 212, which contact the gasket 221 are vulnerable to an insulation effect. Thus, dew condensation may occur due to a temperature difference between the inside and the outside of the refrigerator.

To prevent the dew condensation from occurring, a CNT heater 1 is disposed on an inner sidewall of the cabinet 210 contacting the gasket 221 of the door 220.

The CNT heater 1 extends in a horizontal direction along a front end of the door 220 to heat the front end of the cabinet 210 contacting the gasket 221 of the door 220.

The CNT heater 1 may be disposed on an inner sidewall of a front end of the partition 212. As necessary, the CNT heater 1 may be disposed on an outer sidewall of the front end of the partition 212.

The CNT heater 1 may be vertically disposed along the partition 212. Also, the CNT heater 1 may have a predetermined width so that it adjacent to the gasket 221 of both sides of the refrigerator compartment door 222 and the freezer compartment door 224.

As described above, since the front end of the cabinet 210 and the front end of the partition 212 are heated by the CNT heater 1, it may prevent the dew condensation from occurring due to a temperature difference between the external air and the internal air.

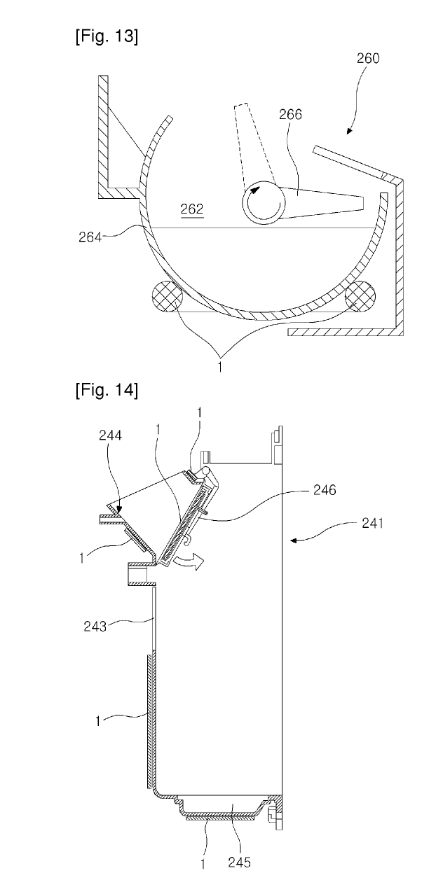

FIG. 12 is an exploded perspective of the door according to the second embodiment, and FIG. 13 is a sectional view of an ice making apparatus according to the second embodiment.

Referring to FIGS. 12 and 13, the door 220 includes an outer case 225, a door liner 226, and an insulation material disposed between the outer case 225 and the door liner 226.

An mounting member 223 is disposed inside the outer case 225 to guide a mounting position of the ice making apparatus 260 and a mounting position of a water supply tube 228 supplying water to the ice making apparatus 260.

The mounting member 223 may be formed of a material equal to the insulation material such as styroform. The mounting member 223 may guide a mount of a connector 227 electrically connected to the ice making apparatus 260.

After the water is supplied from the water supply tube 228 to the ice making apparatus 260, when the water remains in the water supply tube 228, the remaining water within the water supply tube 228 is frozen. As a result, it may be impossible to supply the water to the ice making apparatus 260.

To smoothly supply the water through the water supply tube 228, the CNT heater 1 may be disposed on the water supply tube 228. The CNT heater 1 may be attached to a side of the water supply tube 228 and surround the water supply tube 228.

In detail, the CNT heater 1 may be disposed on a portion at which the water supply tube 228 is exposed, i.e., an end of a side of the water supply tube 228 protruding from the mounting member 223. The CNT heater 1 may be disposed on a portion at which the water supply tube 228 contacts at least cool air.

The ice making apparatus 260 is connected to the connector 227 and mounted on the door liner 226. The ice making apparatus 260 includes an ice mould 264 for generating the ices. The ice mould 264 includes a plurality of cells 262 in which the ices are made and an eject pin 266 for dispensing the ices.

The CNT heater 1 contacting the ice mould 264 is disposed on a bottom surface of the ice mould 264.

The CNT heater 1 may have an approximately “U”-shape on the bottom surface of the ice mould 264. Of cause, the CNT heater 1 may have a sheet shape. The ice mould 264 may be formed of a carbon nanotube material or a material mixed with the carbon nanotube material.

When the ices are completely made in the ice making apparatus 260, the CNT heater 1 generates heat. Thus, the made ices are separated from the ice mould 264. Then, the separated ices may drop into or be stored in the ice bank 270 by the guide of the rotating eject pin 266.

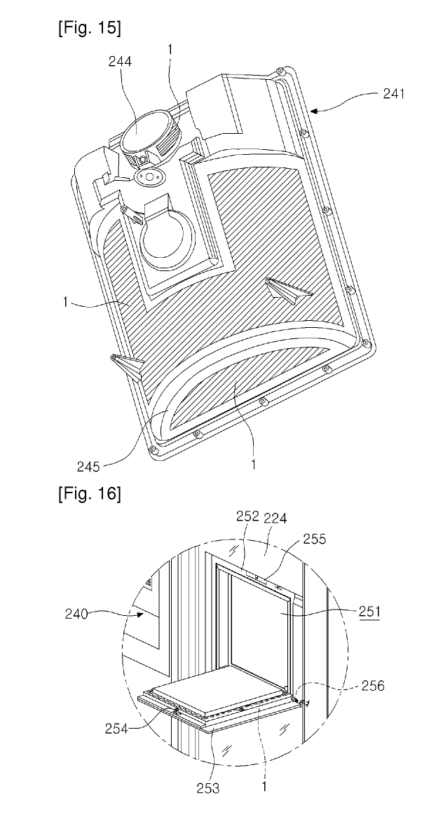

FIG. 14 is a sectional view taken along line B-B′ of FIG. 10, and FIG. 15 is a perspective view illustrating a back surface of a dispenser housing according to the second embodiment.

Referring to FIGS. 14 and 15, the dispenser 240 is disposed on a front surface of the door 220.

The dispenser 240 includes a housing 241 recessed backwardly from the front surface of the door 220, a display 242 disposed above the housing 241, and an operation member 243 disposed inside the housing 241.

A remaining water gutter 245 for receiving the water or ices dispensed from the dispenser 240 is disposed at a lower portion of the housing 241.

An ice chute 244 for guiding the movement of the ices from the ice bank 270 is disposed in the housing 241. A selectively openable chute cover 246 is disposed in an opened lower side of the ice chute 244. The cool air inside of the ice chute 244 may be interrupted by the chute cover 246.

When a user operates the operation member 243, the chute cover 246 may be opened to dispense the ices. In a state where the operation member is not operated, the chute cover 246 covers the ice chute 246.

Since the housing indirectly contacts the cool air within the refrigerator and has the backwardly recessed shape, the housing is vulnerable to an insulation effect. Thus, the dew condensation may occur on the housing 241 due to a temperature difference between the inside and the outside of the refrigerator.

To prevent the dew condensation from occurring, the CNT heater 1 is disposed on a back surface of the housing 241.

The CNT heater 1 may cover an whole or almost portion backwardly recessed of the housing 241.

The CNT heater 1 may be disposed on the lower portion of the housing 241 including the remaining water gutter 245 to evaporate the water collected within the remaining water gutter 245.

The ice chute 244 and the chute cover 246 directly contact the cool air within the ice bank 270. Thus, the dew condensation or freezing phenomena may occur due to a temperature difference between the inside and the outside of the ice bank 270.

To prevent the dew condensation from occurring, the CNT heater 1 may be disposed on the ice chute 244 and the chute cover 246.

In detail, the CNT heater 1 may be disposed along a circumference of the ice chute 244. Also, the CNT heater 1 may be disposed along an entire back surface or a circumference of the chute cover 246.

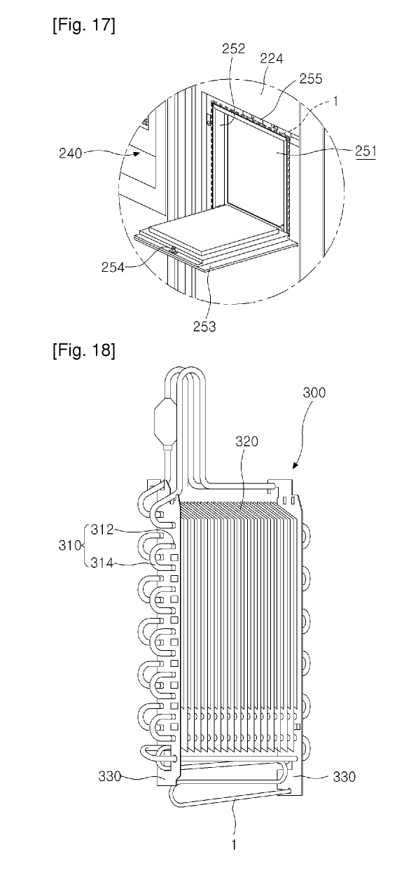

FIGS. 16 and 17 are partially perspective views of a state in which a home bar door is opened according to the second embodiment.

Referring to FIGS. 16 and 17, a home bar 250 is disposed in the door 220 of the refrigerator 200. The home bar 250 is configured to easily withdraw foods received on the back surface of the door 220 without opening the door 220.

The home bar 250 includes a home bar frame 252 defining an opening 251 and a home bar door 253 selectively covering the opening 251.

Hinges 256 for automatically opening and damping the home bar door 253 are disposed on both ends of the home bar door 253 and coupled to the home bar frame 252.

A latch 254 for fixing the home bar door 253 is disposed on the home bar frame 252. A restraint unit 255 for selectively restraining the latch 254 is disposed on the home bar frame 252 corresponding to the latch 254.

When the home bar door 253 is closed, a portion at which the home bar door 253 is adjacent to the home bar frame 252 is vulnerable to an insulation effect. Thus, the dew condensation may occur due to the temperature difference between the inside and the outside of the refrigerator.

To prevent the dew condensation from occurring, the CNT heater 1 is disposed along an inner circumference of the home bar door 253. The CNT heater 1 may have a wire or sheet shape.

Also, the CNT heater 1 may be disposed on the home bar frame 252 contacting the home bar door 253.

Since the home bar door 253 and the home bar frame 252 are heated by the CNT heater 1, it may prevent the dew condensation from occurring on a portion at which the home bar door 253 is coupled to the home bar frame 252.

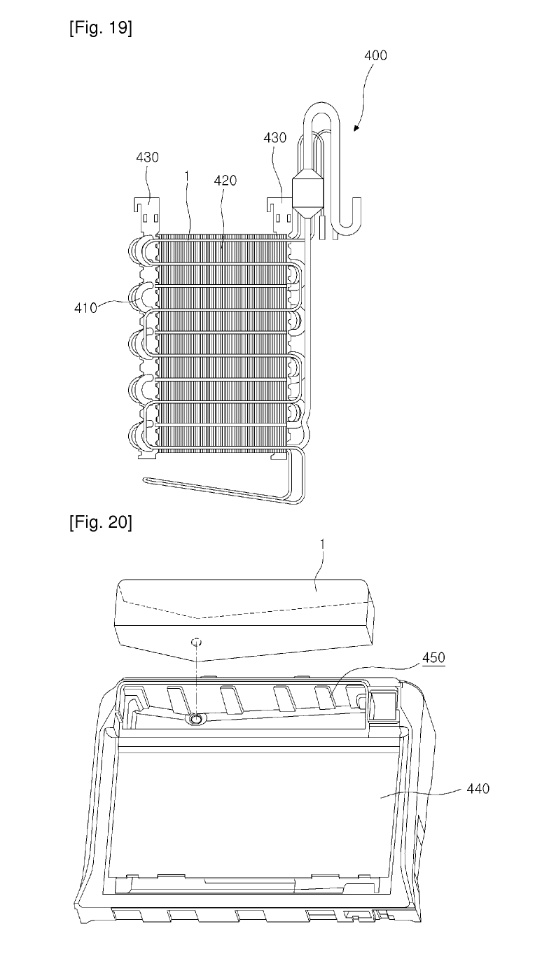

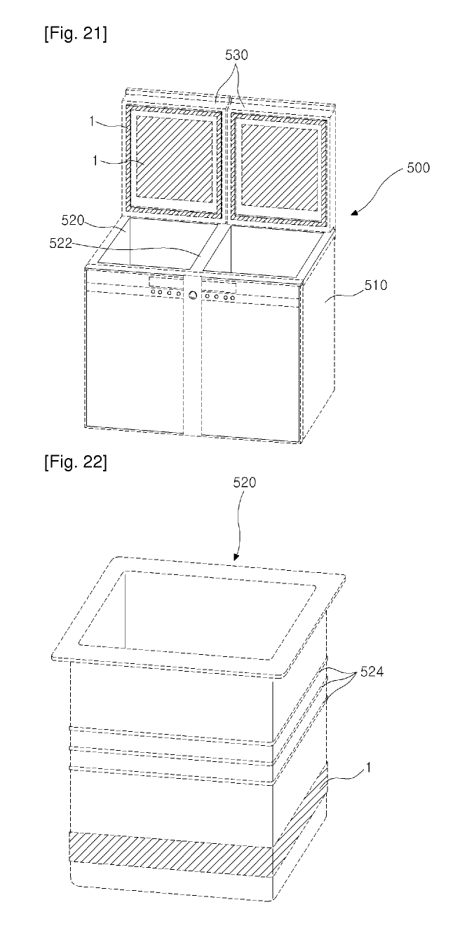

FIG. 18 is a perspective view of a heat-exchanger in which a CNT heater is installed according to the second embodiment. FIG. 19 is a perspective view of a heat-exchanger in which a CNT heater is installed according to a third embodiment. FIG. 20 is a perspective view of a drain part in which a CNT heater is installed according to a fourth embodiment.

Referring to FIG. 18, a heat-exchanger 300 includes a sequentially bent refrigerant pipe 310 and a plurality of heat-exchanging pins 320 through which the refrigerant pipe 310 passes.

The refrigerant pipe 310 may guide the movement of a refrigerant flowing into a refrigeration cycle to heat-exchange with air within the refrigerator. The refrigerant pipe 310 has a pipe shape having a predetermined diameter.

The refrigerant pipe 310 includes straight pipes extending in a horizontal direction and connection pipes 314 connecting the vertically disposed straight pipes 312 to each other. The straight pipes 312 and the connection pipes 314 may be continuously disposed.

Each of the heat-exchanging pins 320 increases an area contacting the air within the refrigerator to improve heat-exchange efficiency. The heat-exchanging pin 320 includes a plurality of pins passing through the refrigerator pipe 310.

Mounting brackets 330 for supporting the refrigerator pipe 310 and mounting the heat-exchanger 300 are disposed on both left and right sides of the heat exchanging pin 320. The CNT heater 1 is disposed at a lower side of the mounting bracket 330.

The CNT heater 1 removes frost condensed on the heat-exchanger 300. During a defrosting operation, the CNT heater 1 is configured to generate heat. The CNT heater 1 may have a wire shape, like a general defrosting heater. The CNT heater 1 may be bent many times.

The CNT heater 1 may have a sheet shape having a predetermined area or a block shape having a predetermined volume to directly heat the heat-exchanger 300. A plurality of heating elements constituting the CNT heater 1 may be sequentially disposed.

Referring to FIG. 19, a heat-exchanger 400 includes a refrigerant pipe 410 bent many times, a plurality of heat-exchanging pins 320 through which the refrigerant pipe passes, and mounting brackets 430 disposed on both sides of the respective heat-exchanging pin 420 to allow the heat-exchanger 400 to be mounted.

A CNT heater 1 is disposed on front and rear surfaces of the heat-exchanger 400. The CNT heater 1 contacts the heat-exchanger 400 to directly heat the heat-exchanger 400. The CNT heater 1 may extend from an upper portion of the heat-exchanger 400 up to a lower portion of the heat-exchanger 400.

Referring to FIG. 20, a drain part 450 is disposed at a side of the inside of a refrigerator at which a heat-exchanger 400 is disposed. The drain part 450 is disposed below the heat-exchanger 400 to collect water generated during a defrosting operation.

The drain part 450 may be recessed downwardly to receive a lower portion of the heat-exchanger 400.

The drain part 450 may be disposed at various positions according to configurations of the refrigerator. For example, the drain part 450 may be disposed at a position at which the heat-exchanger 400 is disposable, e.g., on an inner case 230 or barrier 440.

A CNT heater 1 is disposed on the drain part 450 to prevent water collected in the drain part 450 from being frozen.

The CNT heater 1 may have a shape corresponding to that of the drain part 450. The CNT heater 1 may generate heat during the defrosting operation or before and after the defrosting operation is performed to smoothly discharge the water. Also, the CNT heater 1 may indirectly heat the heat-exchanger 400 to promote a defrosting effect.

The CNT heater 1 may adhere or be attached to the drain part 450. Also, a heating element 40 may be coated on the drain part 450.

An injection molded part corresponding to the drain part 450 may be formed of a carbon nanotube material or a material containing the carbon nanotube material to manufacture the CNT heater 1.

FIG. 21 is a perspective view of a chest type refrigerator with a door opened according to a fifth embodiment, and FIG. 22 is a perspective view of an inner case according to the fifth embodiment.

Referring to FIGS. 21 and 22, a refrigerator 500 according to a fifth embodiment includes a cabinet 510 defining an outer appearance of the refrigerator 500 and a door 530 selectively covering an opened top surface of the cabinet 510.

An inner case 520 defining a storage space is disposed inside the cabinet 510. An insulation material is disposed between the cabinet 510 and the inner case 520. The storage space defined by the inner case 520 may be partitioned by a barrier 522.

A refrigerant pipe 524 and a CNT heater 1 are disposed on an outer surface of the inner case 520.

In detail, the refrigerant pipe 524 through which a refrigerant flows may be wounded many times on an upper circumference of the outer surface of the inner case 520 to cool the storage space in a direct cooling manner.

The CNT heater 1 may be disposed at a lower side of the refrigerant pipe 524, i.e., a lower position of the inner case 520 to heat the inside of the storage space.

The CNT heater 1 may have a sheet shape having a predetermined area. The CNT heater 1 may be attached along a circumference of the inner case 520. Also, heating elements (see reference numeral 40 of FIG. 2) are disposed with a certain distance, and both ends of each of the heating elements 40 may be connected to electrodes (see reference numeral 30 of FIG. 2).

Also, the heating element 40 may be coated on the inner case 520, or at least portion of the inner case 520 may serve as the heating element 40.

The door 530 may be provided in plurality to selectively cover top surfaces of the partitioned storage spaces.

The CNT heater 1 may be disposed inside the door 530 to easily heat the storage space. The CNT heater 1 may be disposed on an inner sidewall of the door 530 contacting the storage space.

The CNT heater 1 may be disposed on a circumference contacting the cabinet 510 of the door 530. Due to the CNT heater 1, it may prevent dew condensation from occurring on a portion at which the door 530 contacts the cabinet 510.

As described above, the CNT heater 1 may be disposed at various positions within the refrigerator in which the heat is required except the positions described in the previously described embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A heater for a refrigerator, comprising:
a heating part disposed on a heating object constituting the refrigerator and at which heat is required,
an insulation sheet disposed at a side of the heating part;
a plurality of electrodes coupled to the insulation sheet, the electrodes supplying a power; and
a heating element disposed between the plurality of electrodes, the heating element being formed of carbon nanotube (CNT) to generate the heat.

2. The heater according to claim 1, wherein the heating element is attached to the heating object or contactingly fixed to the heating object using a separate fixing member.

3. The heater according to claim 1, wherein the heating element is deformed to constitute at least portion of the heating object.

4. The heater according to claim 1, wherein the heating element is provided in plurality, the plurality of heating elements being spaced a preset distance from each other, and
both ends of the heating element are connected to each other by the plurality of electrodes.

5. The heater according to claim 1, wherein an anti-oxidation layer is coated on the heating element to prevent the heating element from being oxidated by external air or cool air.

6. The heater according to claim 1, wherein the heating object is disposed on a portion, with which a refrigerator door contacts, of a cabinet defining a storage space.

7. The heater according to claim 6, wherein the heating object is disposed on a portion, with which the refrigerator door contacts, of a barrier partitioning a storage space.

8. The heater according to claim 1, wherein the heating object is disposed at a side of a heat-exchanger generating cool air.

9. The heater according to claim 8, wherein the heating object is disposed on a drain part collecting defrosted water generated during defrosting operation of the heat-exchanger.

10. The heater according to claim 1, wherein the heating object is disposed on a back surface or a bottom surface of a dispenser housing for dispensing an ice.

11. The heater according to claim 10, wherein the heating object is disposed on a dispenser chute that is a passage for dispensing the ice or a chute cover opening and closing the dispenser chute.

12. The heater according to claim 10, wherein the heating object is disposed on an ice maker for making the ice or a water supply tube supplying water to the ice maker.

13. A refrigerator comprising:
a cabinet defining a storage space;
a refrigerator compartment defined at an upper portion of the storage space, the refrigerator compartment storing foods in a refrigeration state;
a freezer compartment defined at a lower portion of the storage space, the freezer compartment storing the foods in a frozen state;
a barrier partitioning the refrigerator compartment and the freezer compartment;
a plurality of doors selectively covering the refrigerator compartment and the freezer compartment; and
a carbon nanotube (CNT) heater disposed on the cabinet or doors, the CNT heater being formed of carbon nanotube to provide a heat source.

14. The refrigerator according to claim 13, wherein lateral gaskets are disposed on the plurality of doors to closely attach the doors to each other, and
the CNT heater is disposed at a side of the respective lateral gaskets.

15. The refrigerator according to claim 13, wherein the plurality of doors includes a refrigerator compartment door in which ice compartment is defined, and
the CNT heater is disposed at a side of a cool air duct defining a cool air passage between a heat-exchanger and the ice compartment.

16. The refrigerator according to claim 15, further comparing an inner case in which a cool air hole selectively communicating with the ice compartment is defined, the inner case defining an inner appearance of the cabinet,
the CNT heater is disposed at a side of the cool air hole.

17. A refrigerator comprising:
a cabinet defining a storage chamber partitioned into left and right sides by a partition;
a door selectively covering the storage chamber; and
a carbon nanotube (CNT) heater disposed on the cabinet or doors, the CNT heater being formed of carbon nanotube to provide a heat source.

18. The refrigerator according to claim 17, further comprising:
a home bar door selectively covering an opening of the door; and
a home bar frame contacting the home bar door,
wherein the CNT heater is disposed on a portion at which the home bar door contacts the home bar frame.

19. The refrigerator according to claim 17, further comprising a heat-exchanger generating cool air supplied to the storage chamber,
wherein the CNT heater is disposed at a side of the heat-exchanger to indirectly heat the heat-exchanger or contacts the heat-exchanger to directly heat the heat-exchanger.

20. The refrigerator according to claim 17, further comprising an inner case defining an inner appearance of the cabinet,
wherein the CNT heater is disposed along a lateral surface or a circumference of the inner case.
